(19) United States
(12) Patent Application Publication
(10) Pub. No.: US 2026/0264249 A1
(43) Pub. Date: Sep. 10, 2026

(54) SYSTEM AND METHOD FOR CALIBRATING A ROBOTIC ARM

(71) Applicant: Óbudai Egyetem, Budapest (HU)

(72) Inventors: Péter Galambos, Herceghalom (HU); József Kuti, Tura (HU); Tamás Haidegger, Budapest (HU); Tamás Piricz, Budapest (HU)

(21) Appl. No.: 19/491,381

(22) PCT Filed: Jun. 5, 2024
(86) PCT No.: PCT/HU2024/050041

§ 371 Date: Dec. 8, 2025

(30) Foreign Application Priority Data
Jun. 8, 2023 (HU) P2300190

(51) Int. Cl. B25J 9/16

(52) U.S. Cl. CPC B25J 9/1692; B25J 9/1674; B25J 9/1697

(57) ABSTRACT

SYSTEM AND METHOD FOR CALIBRATING A ROBOTIC ARM The invention relates to a system and method for calibrating a robot arm, comprising a plurality of segments connected to each other by joints between a fixed segment and an end flange, a robot controller, a sensor module, a computing unit, the computing unit comprising a communication module, a power supply, a processor, and a program. One or more sensor modules are attached to the robotic arm, the sensor module (1) comprises at least one camera (4) and a communication module, and the sensor module (1) is connected to the computing unit (2) via a data transmission channel, the computing unit (2) is connected to the robot controller (11) via a data transmission channel and comparing by it the calculated position and orientation data (TP) from the joint position (Q) read out from the robot controller (11) with the obtained position and orientation data (T), acquired directly from the sensor module (1) performing the measurement or via the computing unit (2), thereby verifying the robot controller (11), and allow to minimize the difference between the position and orientation data from the robot controller (11) and those from one or more sensor modules (1), which are used to calibrate the robotic arm (10).

The invention relates to a system and a method for calibrating a robotic arm, the system comprising a robotic arm with a plurality of segments connected to each other by joints between a fixed segment and a flange (providing connection to an end effector), a robot controller, a sensor module, a computing unit, the computing unit comprising a communication module, a power supply, a processor and a program.

Robot arm calibration is a process used to improve the accuracy of robots, especially industrial robots. Industrial robotic arms consist of several segments connected by joints between a fixed segment and a flange. Industrial robots can repeat their pre-programmed movements in large numbers. The robot controllers are able to adjust the joint angles connecting each of the elements that make up the robotic arm to a predefined position and to change the position of the joints according to a predefined trajectory. The spatial location of the robotic arm end-effector depends on the geometry of a given manipulator, which is unique for each robotic arm produced due to manufacturing variations, varies slightly under load, and depends on a zero (native) angle value set in the motor controllers. Due to external influences, the geometry of the robot can change slightly, which can lead to production quality and process quality problems in the parts and products produced by the robotic arm and the result of the robotized process, resulting in different 3D movements.

The calibration of the robotic arm comprises the determination of an accurate, approximate model of each robot according to the task at hand, which is called the robot model.

The calibration procedures can be divided into three levels based on the change of the robot model:
The purpose of level 1 calibration is to determine the position of the robotic arm in space and the position of any additional devices relative to the stationary or moving parts of the robotic arm.
The aim of level 2 calibration, also known as kinematic calibration, is to describe the robotic arm as a mechanism as accurately as possible. This specifies and refines the computational procedure for determining the relation of the measured joint positions at each joint to the 3D positions-orientations. There are several parameterizations for the computational procedure, the most commonly used is the so-called Denavit-Hartenberg (also known as DH) parameterization [1], and a modification known as the Hayati parameterization [2]. In mechanical engineering, the DH parameters are four parameters describing the elements of a spatial kinematic chain or robot manipulator and their coupling, which can be interpreted according to a particular convention. Several descriptions exist, with different advantages and disadvantages. For example, the model proposed by Hayati uses four parameters in a similar way, but has different advantages and disadvantages in numerical calculations.
Level 3 calibration, also known as non-kinematic calibration, models errors other than geometric defaults, such as stiffness, joint compliance and friction. But there are also much more complex procedures based on soft computing methods-the latter is called non-parametric calibration. Level 1 and 2 calibrations are sufficient for most practical needs.

The robot controller determines which angle values to impose on the electronics that controls the joints based on the calculation process that contains the robot model, so the accuracy of the resulting motion is limited by the accuracy of the robot model used for the calculations.

Camera-based displacement determination in unstructured environment is called the Simultaneous Localization and Mapping (SLAM) problem. Procedures known per se are available for conventional mono-camera, stereo-camera, and multi-camera systems. As the accuracy and number of cameras increase, the accuracy of the estimated position and orientation increases as well.

The state of the art is to use dedicated measurement devices for robot calibration: multi-camera systems, special adjustment patterns, laser distance measuring devices, or other device system with a reference position fixed outside the robot that implements a measurement procedure independent of the robot to measure the spatial position of one or more points on the robot.

Patent document US10812778B1 discloses a robot calibration system and method based on the attachment of one or more 3D sensors to a moving manipulator. This patent uses a multi-camera system to determine the relative displacement of objects, and based on this, provides the possibility to determine the position of the robot arm and the cameras relative to each other, i.e., a level 1 calibration. The purpose of the calibrated system is, among other things, to detect 3D irregularities of the surface to be machined/carrier surface using a multi-camera system and to modify the robot arm movement based on these. It does not deal with the level 2 calibration of the robot arm, i.e., the verification and refinement of the robot model.

The subject matter of patent JP2001050741A is automated robot calibration of level 2. The arm has 6 or more independent degrees of freedom, therefore the robot tool tip can be set to any position and orientation from which teaching points are selected. The robot can be accurately adjusted to these positions by applying force to the tip of the arm while colliding with a seat, or the arm of a 3D measuring machine, or by measuring its position with another high-precision measuring system. The calibration is based on the 3D position and joint position pairs recorded. Calibration requires tools not available in dedicated industrial processes.

State of the art robot calibration procedures cannot be applied during the normal use of the robot, but require the robot to be removed from the production process, the installation of special devices on the robot and its environment is required and the robot can not to be used for dedicated work while the calibration is being performed.

The need therefore arose for a system to ensure continuous calibration of the robotic arm, which does not require it to be taken out of production during the calibration process, but can be used during its normal operation and allows continuous calibration.

With this invention, we aim to eliminate the above-mentioned problems and to satisfy the mentioned needs.

These goals can be achieved with a system according to claim 1 and a method according to claim 10. Preferred embodiments of the system and method according to the invention are defined by the dependent claims.

The method according to the invention is described in detail below with reference to the figures, where

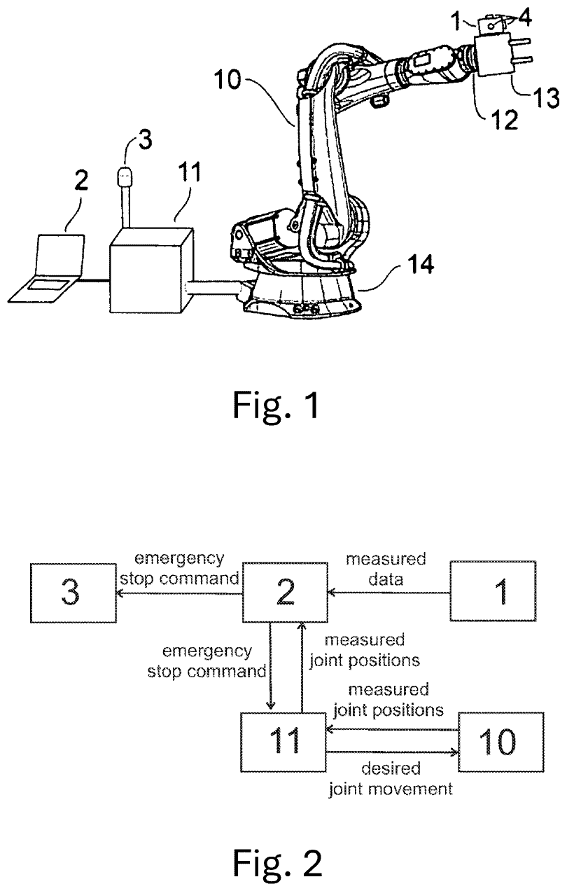

FIG. 1 is a possible embodiment of a robotic arm used in the system and method for calibration according to the invention, shown in perspective view,

FIG. 2 is a general block diagram of the operation of the robotic arm calibration method according to the invention,

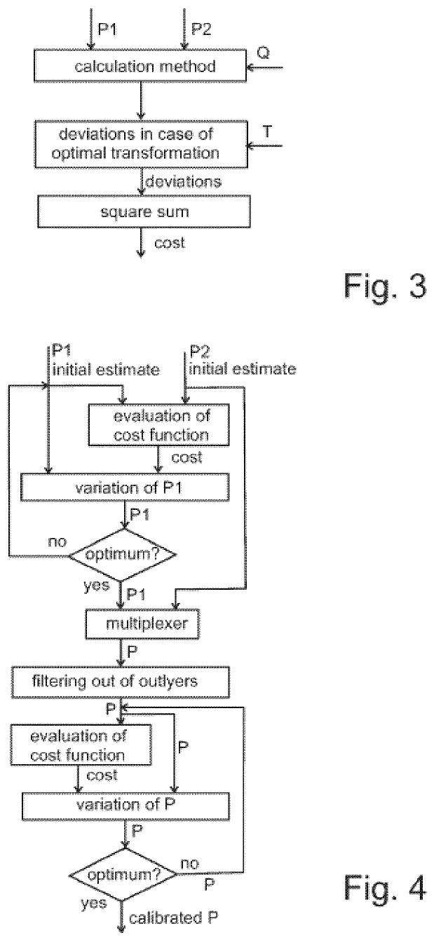

FIG. 3 is the flowchart of a procedure for determining the value to be minimized in the calculation method with a given parameterization and the values from a given measurement, and

FIG. 4 is a flowchart of the calibration method and system operation according to the invention.

In the Figures, the same elements are shown with the same reference numerals.

FIG. 1 shows the elements of the calibration system for a robotic arm 10: the robotic arm 10 itself, a robot controller 11, an end flange 12, an end device 13, a fixed segment 14 that enables the robotic arm 10 to perform a given sequence of mechanical operations. All these elements are known from the prior art. Preferably, the end device 13 can be interchanged with a tool suitable for a given job, e.g., a drill, a screwdriver, a welder, etc. The robot controller 11 can also be integrated with the robotic arm 10. According to an illustrated embodiment of the present invention, a sensor module 1 is used with cameras 4 on it, and all of these are installed on the end device 13 as shown in FIG. 1, and computing devices 2 and displays 3, installed outside the robotic arms 10, are used.

In general, the sensor module 1 mounted on the end flange 12 of the robotic arm 10 or on the end device 13 comprises a plurality of cameras 4. In other embodiments, several sensor modules 1 are arranged at different points on the robotic arm 10, important is only that one or more sensor modules 1 together will comprise at least one camera 4. The one or more sensor modules 1, or one of them, may optionally be equipped with a sensor unit (inertial sensor) INS. The sampling frequency of the sensor module 1 equipped with a plurality of cameras 4 and optionally with a sensor unit INS is preferably at least 100 Hz. The sensor module 1 may be further equipped with other sensor units-these may include a gyroscope, a magnetometer, a lidar and/or an accelerometer. Alternatively, an IR (infrared) or external illumination may be used in low-light operating environment. The images and, optionally, angular velocity and acceleration data detected by one or more sensor unit(s) of sensor module 1 are fed into a computing unit 2, which determines the spatial position (position and orientation) and the change of position (velocity, angular velocity) of the end flange 12 of the robotic arm 10 by real-time processing of the measured data. The computing unit 2 also communicates with the robot controller 11, from which it extracts the spatial position and orientation data of the end flange 12 of the robotic arm 10. The computational process running on computing unit 2, which is an essential element of the invention, continuously compares the position data from the robotic arm 10 and the measurement and sends an alarm to the display 3 and/or an emergency stop signal to the robot controller 11 in case of inconsistent detection exceeding a predetermined threshold value.

The computing unit 2 includes a communication module, a power supply, a processor and a program. The computing unit 2 is also capable of revising the calculation procedure to resolve inconsistencies that exceed the threshold. This is called calibration mode. If the inconsistency is caused by some non-time-varying inconsistency, the computing unit determines a calculation procedure during the calibration mode, which is suited to the structure of the robotic arm 10 in order to reduce the inconsistency below the threshold. Examples of such non-time-varying threshold deviations are the distance between points or the angular deviation of orientations, or a weighted combination of these.

FIG. 2 shows in a block diagram the way in which the different components communicate during operation. The sensor module 1 transmits position data, or measured data allowing the determination thereof, to the computing device 2, which are compared with the measured joint positions from the robotic arm 10 via the robot controller 11. The joints can be capable of rotating or linear movement. The computing device 2 performs the verification and calibration and, if necessary, sends an emergency stop command to the robot controller 11 and displays it on display 3. The robot controller 11 is also responsible for communicating and controlling the desired joint movements to the robotic arm 10.

The calibration procedure is based on the following assumptions:
A relatively good estimate is provided for the computational procedure (currently it is based on the DH robot modelling procedure [1], which has parameters and distances and enclosed angles of the rotation axes of the joints, 4 per joint, so for example for a 6 jointed industrial robot arm a total of 24 parameters, and the approximate position and orientation of the sensor module with respect to the end flanges 12. The initial estimate can be the parameterization of the product design, called nominal model, or the result of the last calibration.
A given trajectory is followed, while the joint variables of the robot arm 10 move over a relatively wide range.

During the movement, the joint positions of the robotic arm 10 are stored in time with the position and orientation data determined by the visual system. The purpose of the calibration is to refine the parameters of the calculation procedure whereby, in case the position of the visual system, i.e. of at least one of the one or more sensor modules 1, is calculated from the joint positions and compared with the calculated positions from the visual system data, the sum of the squared deviations will be within a predefined threshold.

The optimization, i.e., the provision of a more accurate calculation procedure, is done in several steps:
1. First only a level 1 calibration is performed: the relative position of the visual sensor, i.e. the camera 4, with respect to the end flange 12 is determined, with the accuracy allowed by the initial computation procedure. (This allows to exclude outliers likely to be due to measurement error and to repeat the first step more accurately on the filtered data set.)
2. Based on the resulting model and data set, improving the parameterization of the entire robot arm 10 by finding parameters that minimize the sum of squared deviations.

In one embodiment, the computing unit 2 has an output connected to an emergency stop triggering input of the robot controller 11, which output is activated when certain conditions are met. Such a condition could be, for example, if the difference between the data compared during the verification exceeds a certain threshold or the magnitude of the time derivative of the difference exceeds a threshold.

FIG. 3 shows the determination of the cost value for a given parameter P. Cost is the term used in the industry to describe the scalar value to be minimized later on. The first step is to initially estimate (initialize) the parameters P of the computational procedure. The sub-parameters P1 of the parameters P determine the position and orientation of the sensor module 1 with respect to the end flange 12, while the sub-parameters P2 determine the others (the internal geometry of the robot arm 10, in the above case the DH parameters). Using these parameters, for the joint positions Q, the positions and orientations of the sensor module 1 with respect to a coordinate system fitted to the fixed segments 14 can be determined by the computational procedure, these are denoted by positions and orientations TP. The positions and orientations T defined by sensor module 1 are determined and fed in with respect to the other coordinate system fitted to the fixed segments 14. The deviations of positions and orientations T and positions and orientations TP are defined in a common coordinate system using an optimal transformation, the sum of their squares is considered as the cost to be minimized, and their definition as a cost function.

FIG. 4 shows the operation and flowchart of the calibration procedure. In a first step, the minimum cost is found by varying the sub-parameters P1. For this purpose, the initial estimate of the sub-parameters P1 and P2 is used to determine the corresponding cost value as shown in FIG. 3. Then, after varying the sub-parameters P1, the procedure is repeated, again and again with modified sub-parameters P1, until the available information indicates that the sub-parameters P1 result in a minimum cost within the possibilities of the initial sub-parameters P2. This corrects the usually less accurately known sub-parameters P1 without modifying the sub-parameters P2 to keep the inaccuracies of the same order of magnitude. This is followed by another cost minimization, this time an optimization of the parameters P. For this purpose, the parameters P are assembled, based on the previously defined sub-parameters P1 and the initial sub-parameters P2. Joint positions Q and positions and orientations T with outlier errors for these parameters P are filtered out. Then, for the parameters P, determine the cost value as shown in FIG. 3, vary the value of P and repeat the procedure with the modified value of P until some of the parameters P give a minimum cost value.

During the minimization of the cost function, the sub-parameters P1 and later the parameters P are varied by a suitably chosen automatic numerical procedure—the Nelder-Mead simplex procedure, which has been repeatedly re-initialized in practice [4]. The Nelder-Mead simplex procedure is a function minimization method that varies the parameters from the evaluations of the objective function in the probable direction of the minimum. The process, by continuously reviewing the results of the iterations, is adaptive so that the computation best matches the nature of the function known only at points and gradually converges to the local minimum over the iterations. By iteratively applying variations, it is possible to determine the variables that result in the minimum value, in this case the pre-calibrated sub-parameters P1 and then the calibrated parameters P, with a given adjusted accuracy.

The verification of the calculation procedure is based on the following assumptions:
the position and orientation TP data can be retrieved from the robot controller 11, or it can be calculated from the joint positions Q using the latest calculation procedure.
given the joint positions Q, time synchronized with the position and orientation data T from the 1 sensor module.

The check examines the accuracy with which the positions and orientations T and the positions and orientations TP can be matched with each other by the calculation procedure. The calculation procedure is characterized by the magnitude of the cost, as shown in FIG. 3.

The robotic arm 10 of the invention can be calibrated continuously or periodically during normal use.

The computing unit 2 can also be provided with an interface designed to extract the parameters P of the computation mode that results in the minimum deviation during calibration. The invention is particularly advantageous in the following cases:
Continuous geometric inspection of an industrial robot during operation.
Determining or verifying (calibration) the geometric model (deviation from nominal) of a newly manufactured industrial robot or other manipulator.
Continuous monitoring of the fixation or possible deformation of an accessory mounted on the end flange of the robot.
Geometric and kinematic verification of special purpose manipulators in operation:
   Manipulators for medical purposes (e.g., surgical robots, radiotherapy devices),
   Power plant manipulators,
   Other automatic motion equipment for mission critical applications,
   Robotic arms for use in space.
Calibration of detachable modular manipulators after installation.

Advantages of the invention:
It allows continuous calibration.
It does not require an external reference point, pattern or reference light source.
The calibration device can be placed on the robot itself or on the robot arm.
The calibration device can remain on the robot during operation.
Because the system is continuously monitoring, it can alert the operator in the event of a significant deviation and stop the robot to prevent damage.
In the case of less significant deviations, it is possible to correct the model during operation, thus maintaining the robot's accuracy.

The above method and system are preferable for absolute position sensors, but it is also possible to implement a method based on small displacements instead of absolute positions, which searches the parameters with a Kalman filter.

### LIST OF REFERENCED DOCUMENTS

[1] Denavit, Jacques, and Richard S. Hartenberg. “A kinematic notation for lower-pair mechanisms based on matrices.” J. Applied Mechanics 22 (June 1955): 215-221.

[2] S. A. Hayati, “Robot arm geometric link parameter estimation,” in The 22nd IEEE Conference on Decision and Control. IEEE, 1983, pp. 1477-1483.

[3] J. Q. Xuan, S. H. Xu et al., “Review on kinematics calibration technology of serial robots,” International journal of precision engineering and manufacturing, vol. 15, no. 8, pp. 1759-1774, 2014.

[4] Olsson, Donald M., and Lloyd S. Nelson. “The Nelder-Mead simplex procedure for function minimization.” Technometrics 17.1(1975 ): 45-51.

### LIST OF REFERENCE SIGNS

1 sensor module
2 computing unit
3 display
4 camera
10 robotic arm
11 robot controller
12 flange
13 end device
14 fixed segment
P parameters
P1 sub-parameters
P2 sub-parameters
Q joint angles
TP calculated position and orientation data
T obtained position and orientation data

1-15. (canceled)

16. A system for real-time kinematic verification of a robotic arm during normal operation, the system comprising:
a robotic arm comprising a plurality of segments connected by joints between a fixed base segment and an end flange;
a robot controller configured to control the joints and provide joint position data (Q);
at least one sensor module rigidly attached to the robotic arm, the sensor module comprising at least a camera configured to acquire image data of an environment; and
a computing unit comprising at least one processor and a memory storing executable instructions;
wherein the computing unit is communicatively coupled to the sensor module and the robot controller and is configured to:
(a) receive the joint position data (Q) and, using a kinematic model of the robotic arm, compute a theoretical pose (TP) of the sensor module;
(b) process the image data to estimate a measured pose (T) of the sensor module relative to the environment by tracking visual features;
(c) continuously, in real time during normal operation, determine a deviation between the theoretical pose (TP) and the measured pose (T); and
(d) when the deviation exceeds a predetermined safety threshold, generate and transmit a safety intervention command to the robot controller to modify motion of the robotic arm.

17. The system of claim 16, wherein the computing unit is configured to estimate the measured pose (T) by processing natural visual features of an unstructured environment surrounding the robotic arm, independent of predetermined fiducial markers (reference patterns) or external reference light sources.

18. The system of claim 16, wherein the sensor module further comprises an inertial measurement unit (IMU) including at least one of: a gyroscope, an accelerometer, and a magnetometer; and wherein the computing unit is configured to fuse data from the IMU with the image data to refine the estimation of the measured pose (T).

19. The system of claim 16, wherein the computing unit is further configured, in a calibration mode, to execute an iterative optimization that updates parameters of the kinematic model so as to minimize a cost function aggregating deviations between multiple theoretical poses (TP) and corresponding measured poses (T), the parameters including an extrinsic transformation between the sensor module and the end flange (P1) and geometric link parameters of the robotic arm (P2).

20. The system of claim 19, wherein the iterative optimization comprises a two-stage calibration including:
a first stage adjusting the extrinsic transformation parameters (P1) while keeping the kinematic geometry of the robotic arm fixed; and
a second stage adjusting the geometric link parameters (P2) based on the adjusted extrinsic transformation parameters (P1).

21. The system of claim 16, wherein the safety intervention command comprises transmitting an emergency stop signal to the robot controller to halt motion of the robotic arm when at least one of:
(i) the deviation exceeds the predetermined safety threshold; or
(ii) a time derivative of the deviation exceeds a threshold.

22. The system of claim 16, wherein the kinematic model is parameterized by Denavit-Hartenberg (DH) parameters.

23. The system of claim 16, wherein the computing unit performs Simultaneous Localization and Mapping (SLAM) based on the image data to estimate the measured pose (T).

24. A method for real-time verification and calibration of a robotic arm during normal operation, comprising:
rigidly attaching at least one sensor module comprising a camera to a segment or an end flange of the robotic arm;
receiving joint position data (Q) from a robot controller and computing a theoretical pose (TP) using a kinematic model;
acquiring image data and estimating a measured pose (T) by tracking visual features;
continuously and in real time determining a deviation between the theoretical pose (TP) and the measured pose (T);
transmitting a safety intervention command to the robot controller when the deviation exceeds a predetermined safety threshold; and
in a calibration mode, minimizing a cost function by updating parameters including an extrinsic transformation between the sensor module and the end flange (P1) and geometric link parameters of the robotic arm (P2).

25. The method of claim 24, wherein minimizing the cost function comprises:
a first stage optimizing the extrinsic transformation (P1) relative to the end flange; and
a subsequent stage optimizing the geometric link parameters (P2) of the robotic arm.

26. The method of claim 24, wherein estimating the measured pose (T) comprises processing natural visual features of an unstructured environment surrounding the robotic arm, independent of predetermined fiducial markers (reference patterns).

27. The method of claim 24, wherein estimating the measured pose (T) comprises performing Simultaneous Localization and Mapping (SLAM).

28. The method of claim 24, wherein transmitting the safety intervention command is further triggered when a time derivative of the deviation exceeds a threshold.

29. A non-transitory computer-readable medium storing instructions that, when executed by a computing unit coupled to a robotic arm, cause the computing unit to perform operations comprising:
receiving joint position data (Q) from a robot controller and computing a theoretical pose (TP) of a sensor module attached to the robotic arm using a kinematic model;
processing image data acquired by the sensor module to estimate a measured pose (T) of the sensor module by tracking visual features;
continuously, in real time during normal operation, determining a deviation between the theoretical pose (TP) and the measured pose (T);
generating and transmitting a safety intervention command to the robot controller when the deviation exceeds a predetermined safety threshold; and
in a calibration mode, executing an iterative optimization to update an extrinsic transformation between the sensor module and an end flange of the robotic arm (P1) and geometric link parameters of the robotic arm (P2).
